(19) United States
(12) Patent Application Publication
(10) Pub. No.: US 2012/0227824 A1
(43) Pub. Date: Sep. 13, 2012

(54) Methods And Apparatus For Gas Compression With Gas Flow Rate And Pressure Regulation

(75) Inventor: Xing YUAN, Austin, TX (US)

(73) Assignee: Austin Scientific Company, Austin, TX (US)

(21) Appl. No.: 13/046,409

(22) Filed: Mar. 11, 2011

(51) Int. Cl. F15D 1/00; F16K 31/02

(52) U.S. Cl. 137/14; 251/129.15

(57) ABSTRACT

A flow control means, such as a mass flow controller, is connected at the supply output stream of a compressed and cooled gas, such as helium, to regulate the flow rate of the gas. Specific embodiments provide in addition to the flow regulator a pressure regulator, such as for example a stepper motor controlled pressure regulator, is connected before or after the flow regulator to regulate the pressure of the output gas. The flow rate and pressure regulators have integrated controllers or user interfaces. Specific embodiments provide programmable controls with attendant user interfaces to program the desired profile of flow characteristics of pressure, including differential pressures, and flow rate. Analog and digital controller embodiments are provided.

### TECHNICAL FIELD

This disclosure relates generally to gas compressors and more particularly to apparatus and methods to regulate the external flow output from a compressor such as a helium gas compressor.

### BACKGROUND

Refrigeration is often achieved by performing external work on a refrigerant gas, such as ammonia or helium gas, through iterations of compression and expansion cycles. In such a cycle, the compression of gas by an external load would warm the gas and reject the heat to a heat sink; the expansion would cool the gas and absorb the heat from the surrounding environment. Helium gas is a particularly effective refrigerant because of its high heat capacity and heat transfer capabilities and is often used in refrigeration devices that achieve near absolute zero temperature.

A helium gas compressor is a device that can facilitate a closed loop helium gas supply and return circuit that includes one or more refrigeration loads. In this arrangement, a helium gas compressor takes in helium gas at a relatively high temperature and low pressure, that is ejected by a refrigeration load, at the compressor return (inlet) side. The compressor compresses and cools the gas and outputs the gas at relatively higher pressure and lower temperature at its supply (outlet) side. The compressed helium gas is then supplied to the refrigeration load or loads, such as a cryogenic coldhead, that is connected in a closed loop with the helium compressor. The load uses the higher pressured and cooled helium gas to perform work, such as cooling the magnets in a magnetic resonance imaging machine. The ejected lower pressured and warmer helium gas from the load is then returned to the compressor return side to be compressed and cooled again by the helium compressor. This process is repeated in order to maintain the cooling of the refrigeration load.

The work done by the load on the gas changes the characteristics of the gas such as the pressure, temperature and flow rate of the gas in the refrigeration cycle. The changes of such characteristics vary with time due to, for instance, the variation in the demands by the load. Since these variations in the profile of the gas characteristics are load-dependent, the variations are not controlled by the end user.

However, there are applications where it would be very useful to be able to finely regulate the pressure and flow rate of the helium gas supply to the load and is independent of the status of the load. The present disclosure describes methods and apparatus for regulating gas flow from the outlet of a compressor system.

### SUMMARY

A flow control means, such as a Mass Flow Controller (“MFC”), is connected at the supply output stream of a compressed and cooled gas, such as helium, to regulate the flow rate of the gas. Specific embodiments provide in addition to the flow regulator a pressure regulator, such as for example a stepper motor controlled pressure regulator, is connected before or after the flow regulator to regulate the pressure of the output gas. The flow rate and pressure regulators have integrated controllers or user interfaces. Specific embodiments provide programmable controls with attendant user interfaces to program the desired profile of flow characteristics of pressure and flow rate. Analog and digital controller embodiments are provided. Finely regulated control is achieved of pressure and fluid flow rate from the outlet to the load connected to the gas compression system of the present disclosure.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a schematic block diagram of an exemplary embodiment of a gas compressor having a mass flow rate and pressure regulated gas supply of the present disclosure.

FIG. 2 is a schematic block diagram of an alternative exemplary embodiment of a regulated gas flow system of the present disclosure.

FIG. 3 is a schematic block diagram of an alternative exemplary embodiment of a gas compressor of the present disclosure.

### DETAILED DESCRIPTION

To achieve the finely regulated control of pressure and fluid flow rate from the cutlet to the load connected to the gas compression system of the present disclosure, a flow control means, such as a Mass Flow Controller, is connected at the supply output stream of a compressed and cooled gas, such as helium, to regulate the flow rate of the gas. Specific embodiments provide in addition to the flow regulator a pressure regulation means, such as for example a stepper motor controlled pressure regulator, is connected before or after the flow regulator to regulate the pressure of the output gas. The flow rate and pressure regulators have integrated controllers or user interfaces. Specific embodiments provide programmable controls with attendant user interfaces to program the desired profile of flow characteristics of pressure and flow rate. Analog and electronic digital controller embodiments are provided.

The achievable range of gas flow controls is determined by the limit of the compressor motor gas throughput within a pre-determined operating pressure range that is set by an adjustable differential pressure regulating valve circuit within the compressor system of present disclosure. This pre-determined operating pressure range must fall within the compressor motor designed operating pressure limits to prevent damage to the motor. For example, helium mass flow rate in Standard Cubic Feet per Minute (“SCFM”) typically operates in the range of 0 SCFM to 6000 SCFM. Specific embodiments utilize check valves with preset maximum supply pressures and/or minimum return pressure to prevent gas counter flow in-to or out-of the compressor system from pressure fluctuations in the load that exceeds the operating pressure limit of the compressor system.

Specific embodiments of a system of the present disclosure contemplate one or more compressor motor of one or more of the following types: reciprocating, rotary, centrifugal, and axial; and include as applicable, but not limited to Scroll compressor capsule, rotary screw, rotary vane, diaphragm and their variants. Oil-lubricated and oil-free motor embodiments are contemplated.

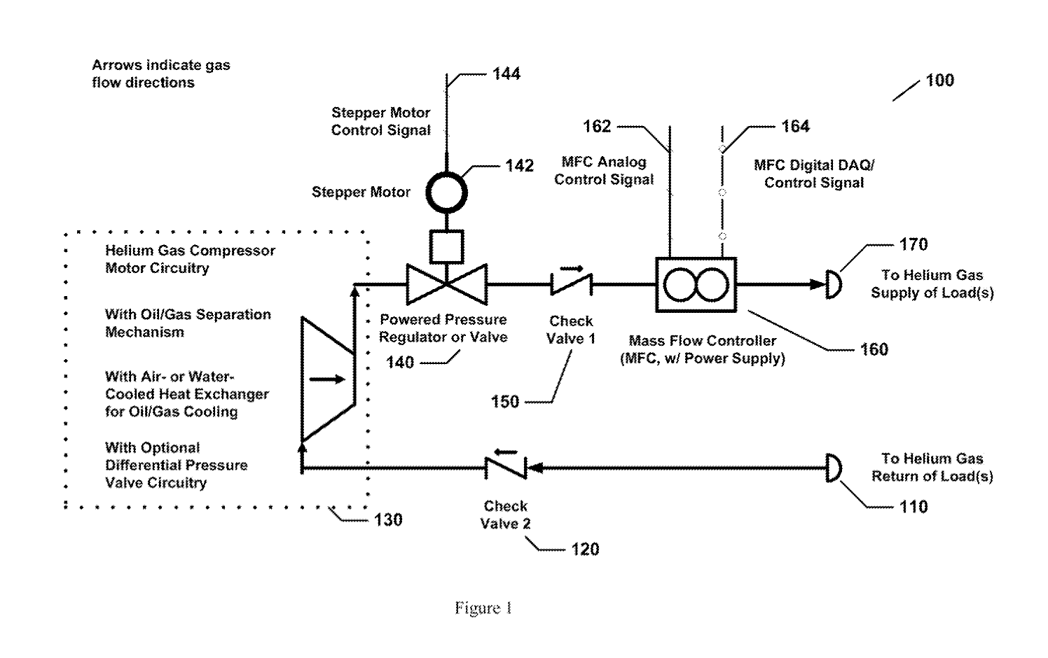

Referring to FIG. 1 of the drawings, FIG. 1 is a schematic block diagram of an exemplary embodiment of a gas compressor having a mass flow rate and pressure regulated gas supply of the present disclosure. The reference numeral 100 generally designates a compressor system embodying features of the present disclosure. The arrows indicate the direction of fluid communication flow. The system 100 includes but is not limited to the following a return port 110, check valve 2 120, compressor motor assembly 130, pressure regulator 140, check valve 1 150, mass flow controller 160 and supply outlet 170.

In operation, working gas returning from load connected to the compressor system passes fluidly from return 110 to check valve 120 before entering compressor motor assembly 130. The gas is cooled in compressor motor assembly 130. A motor such as described above powers compressor motor assembly 130, such motor assembly often incorporates additional mechanisms such as motor oil/gas separation, air or water cooled heat exchange for oil/gas cooling, and differential pressure valve circuits.

Cooled, compressed gas exits the compressor motor assembly 130 and passes through powered pressure regulator valve 140, which in this embodiment is powered by stepper motor 142. The pressure of the exiting gas may be controlled through a user interface or analog controller (not shown) which sends and receives signals 144 from regulator 140.

The gas continues through the system through check valve 1 150 and then through mass flow controller 160. The flow rate of the gas may be controlled by a user with an analog controller (not shown) sending and receiving analog signals 162 from regulator 160 or the flow rate may be controlled electronically through an electronic user interface (not shown) sending and receiving digital signals 164 from regulator 160.

FIG. 1 illustrates a single node with one compressor motor, one pressure regulator and one flow regulator connected in series, to define one node. If a node cannot meet the load requirements of temperature, pressure and flow rate for a particular application, two or more nodes can be connected in parallel to provide the required total flow rate to the load.

Multiple nodes can be connected in series to provide higher operating pressure ranges than would be achievable with a single node. Such a configuration of a series of nodes may be referred to herein from time to time as a “Link.”

Multiple Links can connect in parallel to form a matrix to provide multiples of flow rate and pressure operating pressure range over that of a single node.

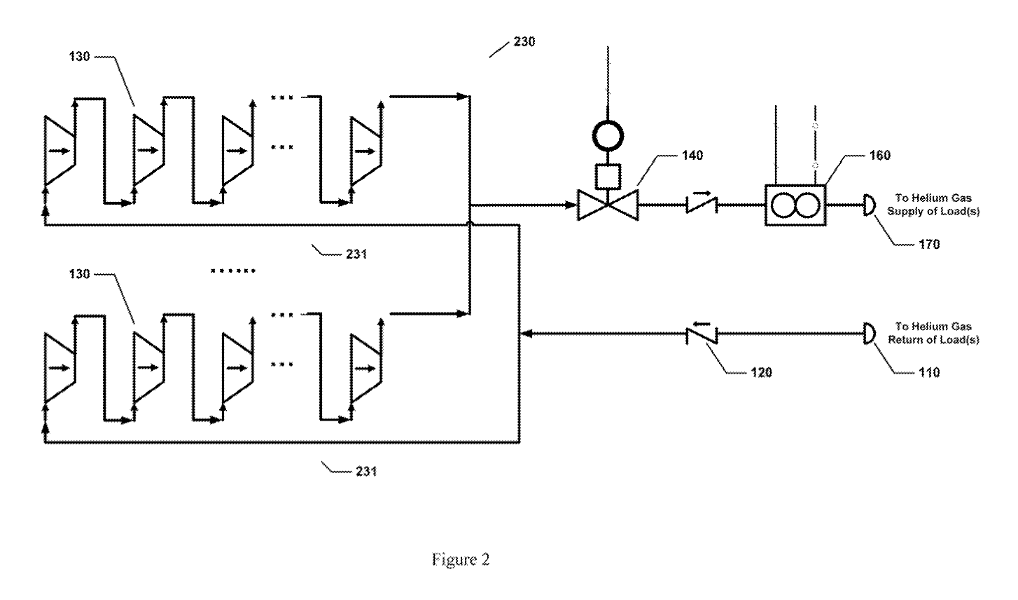

FIG. 2 is a schematic block diagram of an alternative exemplary embodiment of a regulated gas flow system of the present disclosure. Specifically, an exemplary node matrix embodiment is illustrated wherein the gas flow rate and/or pressure regulation control may be optionally unified or separated. The flow rate regulator and pressure regulator are separated from the single nodes in a compressor matrix. Compressor motor assembly links 231 provides a plurality of compressor motor assemblies 130 connected in series. Multiples of links 231 are then connected in parallel to form the compressor matrix 230. The compressor matrix 230 is followed by pressure regulator 140 and flow rate regulator 160 in series as illustrated in FIG. 1. In this embodiment, a user can control the total output of the compressor matrix 230.

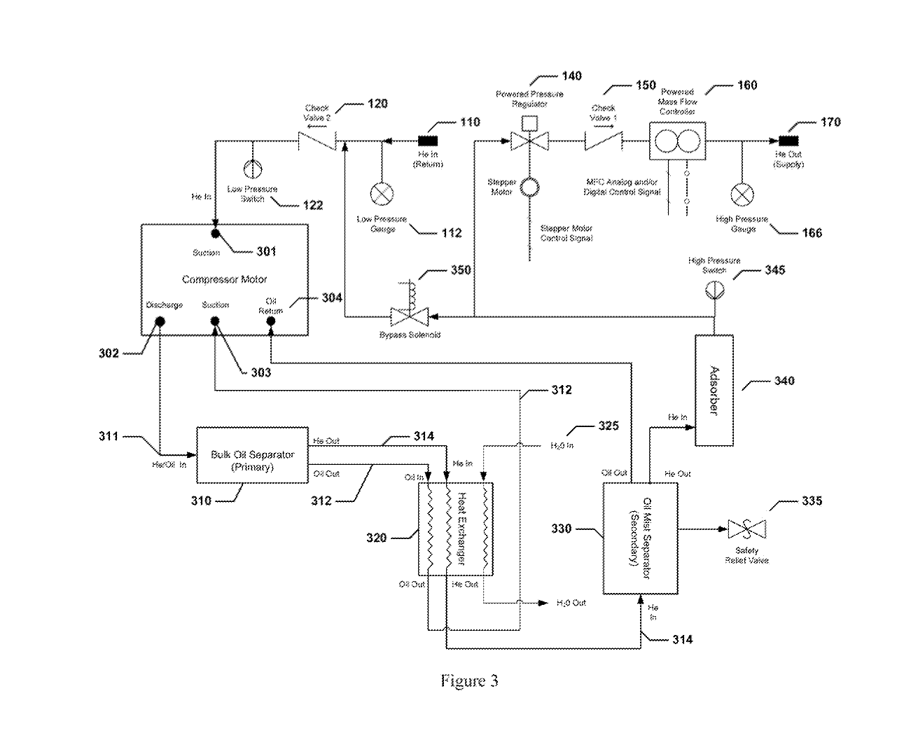

FIG. 3 is a schematic block diagram of an alternative exemplary embodiment of a gas compressor of the present disclosure, with one exemplary configuration of the compressor motor assembly 130 indicated in FIG. 1 and FIG. 2. FIG. 3 illustrates in particular a specific exemplary embodiment of a helium compressor with helium gas flow rate and/or pressure regulated helium working gas supply. Return 110 and outlet 170 are provided as in the previous embodiments. The compressor motor assembly 130 is illustrated in more detail, the core of which is a compressor motor capsule 300 that has a main gas suction port 301, an oil/gas mix discharge port 302, a secondary suction port 303, and an oil return port 304. The working gas returning from the load goes into the motor capsule 300 through the main suction 301. Often within a compressor motor capsule 300, oil is used not only as a lubricant but also as a cooling medium for the motor windings as well as the working gas after being compressed by the motor, creating a high temperature high pressured oil/gas mixture 311. The oil/gas mixture 311 is discharged through discharge port 302 to bulk oil separator 310 where the mixture 311 is separated into oil stream 312 and gas flow 314. The oil 312 and gas 314 pass through a water cooled 325 heat exchanger 320 in separate channels, after which the cooled oil 312 is returned to the compressor motor capsule 300 via the secondary suction port 303.

The cooled gas 314 needs to be further cleaned from the oil, which is present in the gas volume in the form of a mist or vapor. Mist separator 330 removes oil vapor from the gas component 314 and returns the oil to motor capsule 300 via oil return port 304. The gas 314 is further processed through adsorber 340 to remove any residual oil vapor that may still be present and eventually passes through the pressure and flow rate regulators 140, 160 as previously described. Within the compressor system of present disclosure, the pressure differential between the lower-pressured incoming gas and higher-pressured outgoing gas is maintained through an adjustable differential valve (or internal relief valve) assembly 350 that allows a user to set the range within the operating pressure limits of the compressor motor capsule 300. Alternatively, the differential pressure valve 350 may be user selected to have a predefined fixed value. Differential pressure regulation is obtained in specific embodiments with at least one pressure transducer that is capable of and configured to communicating with an external controller device. High pressure switch 345 and low pressure switch 122 provide safety protective mechanism for compressor over-pressure situations. This embodiment further provides high pressure gauge 166 and low pressure gauge 112 for visual indications of the operating pressure status of the compressor system.

Furthermore, the gas inlet (return) port 110, the gas outlet (supply) port 170 and a separate gas charge port (not shown) can be regulated by a solenoid valve for user controllable remote opening and/or closing.

Apparatuses and methods of the present disclosure find utility particularly with refrigeration gases such as helium. The ability to apply a flow of gas with high heat capacity and heat transfer capability to a load with accurate and sustained control of the flow rate and pressure of the gas is advantageous. For instance, industrial crystal growth is hampered by the technical difficulty of maintaining uniform growth temperature conditions at the growth site. Applying a uniform flow of refrigeration gas helps maintain uniform temperature conditions for improved crystal growth quality.

Advantages may also be found in technologies that utilize cryogenics, such as magnetic resonance imaging, electron microscopy, and vacuum creation using cryo-pumping.

Although the foregoing apparatus and methods have been described primarily with reference to helium as the working gas, it will be obvious to those skilled in the art that other gases are also suitable, such as hydrogen, neon, argon, nitrogen, ammonia and so forth.

Many modifications and other embodiments of the apparatus and methods described herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for delivering to a load, at a user-selected gas flow rate profile, a non-load dependent supply of gas from a gas compressor system having at least one compressor motor assembly with differential pressure regulation means, and at least one gas flow regulation means controllable by an external user control means, the method comprising:
determining the range of gas flow rate that can be delivered by said compressor motor assembly;
determining the compressor operating pressure ranges, for both input gas before compression by compressor motor assembly and output gas after compression, that corresponds to the achievable range of gas flow rate;
selecting the gas flow control means having a working flow rate and operating pressure ranges that are within said achievable gas flow rate and operating pressure ranges;
setting the differential pressure value of said compressor system to the difference of the maximum and minimum working pressure when said gas flow control means is set to have zero gas flow rate; and
sending to said gas flow control means the gas flow rate profile for said gas compressor system to deliver desired gas flow rate to the load.

2. The method of claim 1, further comprising connecting a pressure regulation means controllable by an external user control means in series with the gas flow regulation means, the pressure range of said pressure regulation means being selected as the same as that for the working pressure range of the gas flow regulation means.

3. The method of claim 1, further comprising connecting at least two compressor motor assemblies in parallel, and connecting said motor assemblies in parallel to at least one gas flow control means controllable by an external user control means.

4. The method of claim 1, further comprising connecting at least two compressor motor assemblies in series, and connecting said motor assemblies in series to at least one gas flow control means controllable by an external user control means.

5. The method of claim 2, further comprising sending to said pressure regulation means the pressure profile to deliver gas at the desired pressure range to the load.

6. The method of claim 2, wherein only one or the other of gas flow rate or pressure is regulated.

7. The method of claim 1, further comprising selecting the operating ranges of the gas flow regulation means using an electronic controller.

8. The method of claim 1, further comprising selecting the operating ranges of the gas flow regulation means using a programmable controller.

9. The method of claim 1, further comprising selecting the operating ranges of the gas flow regulation means using an analog controller.

10. The method of claim 2, further comprising selecting the operating ranges of the gas pressure regulation means using an electronic controller.

11. The method of claim 2, further comprising selecting the operating ranges of the gas pressure regulation means using a programmable controller.

12. The method of claim 2, further comprising selecting the operating ranges of gas pressure regulation means using an analog controller.

13. An apparatus to deliver to a load a non-load dependent supply of a working gas from a gas compressor system at a user-selected gas flow rate profile, the apparatus comprising:
one or more compressor motor assemblies with differential pressure regulation means;
at least one flow regulation means in fluid communication with at least one of the motor assemblies and controllable by an external user control means; and
at least one gas inlet port and at least one gas outlet port in fluid communication with the flow regulation means.

14. The apparatus of claim 13, wherein two or more of the compressor motor assemblies are connected in parallel.

15. The apparatus of claim 13, wherein two or more of the compressor motor assemblies are connected in series.

16. The apparatus of claim 13, wherein the gas inlet port is a solenoid-driven valve.

17. The apparatus of claim 13, wherein the gas outlet (supply) port is a solenoid-driven valve.

18. The apparatus of claim 13, further comprising a separate gas charge port in fluid communication with the gas inlet.

19. The apparatus of claim 18, wherein the gas charge port is a solenoid-driven valve.

20. The apparatus of claim 13, wherein the working gas of said gas compressor system is helium.

21. The apparatus of claim 13, wherein the gas flow regulation means is an electronic controller.

22. The apparatus of claim 13, wherein the gas flow regulation means is programmable.

23. The apparatus of claim 13, wherein the gas flow regulation means is an analog controller.

24. The apparatus of claim 13, wherein the gas flow regulation means is a Mass Flow Controller (MFC).

25. The apparatus of claim 24, wherein the MFC is an analog controller.

26. The apparatus of claim 24, wherein the MFC is an electronic (digital) controller.

27. The apparatus of claim 24, wherein the MFC is programmable.

28. The apparatus of claim 24, wherein the MFC has an adjustable helium mass flow rate range from 0 SCFM to 6000 SCFM.

29. The apparatus of claim 13, further comprising a gas pressure regulation means controllable by an external user control means, connected in series with the gas flow regulation means.

30. The apparatus of claim 29, wherein the gas pressure regulation means is a stepper motor-driven pressure regulator valve.

31. The apparatus of claim 29, wherein the gas pressure regulation means is an electronic controller.

32. The apparatus of claim 29 wherein the gas pressure regulation means is programmable.

33. The apparatus of claim 29, wherein the gas pressure regulation means is an analog controller.

34. The apparatus of claim 13, wherein the differential pressure regulation means is a differential pressure valve.

35. The apparatus of claim 34, wherein the differential pressure valve is adjustable.

36. The apparatus of claim 34, wherein the differential pressure valve has a predefined fixed value.

37. The apparatus of claim 13, wherein the differential pressure regulation means comprises of at least one pressure transducer that is capable of and configured to communicating with an external controller device.

38. The apparatus of claim 13, wherein the compressor motor assembly comprises of at least one Scroll compressor motor capsule.
